(19) United States
(12) Patent Application Publication
(10) Pub. No.: US 2015/0266434 A1
(43) Pub. Date: Sep. 24, 2015

(54) DECORATIVE LICENSE PLATE FRAME SYSTEM

(71) Applicants: Cary E Gloodt, Burr Ridge, IL (US); Hunter Cranz, Valbez, AK (US)

(72) Inventors: Cary E Gloodt, Burr Ridge, IL (US); Hunter Cranz, Valbez, AK (US)

(21) Appl. No.: 14/663,054

(22) Filed: Mar. 19, 2015

Related U.S. Application Data
(60) Provisional application No. 61/968,012, filed on Mar. 20, 2014.

(51) Int. Cl. B60R 13/10; B60Q 1/56

(52) U.S. Cl. CPC B60R 13/105; B60Q 1/56

(57) ABSTRACT

A decorative license plate frame assembly, including a partially transparent housing defining a windowed frame for mounting a license plate to a vehicle, a light-emitting array positioned within the housing, and a decorative panel connected to the side of the housing, wherein energization of the light-emitting array illuminates the decorative panel.

### CROSS-REFERENCE TO RELATED APPLICATIONS

This patent application claims priority to co-pending U.S. provisional patent application Ser. No. 61/968,012, filed on Mar. 20, 2014.

### TECHNICAL FIELD

The novel technology relates generally to the field of automotive accessories, and, more specifically, to a device for illuminating an embossed figure or symbol on the exterior of a license plate frame.

### BACKGROUND

Automobile accessories are a popular manner in which individuals customize their vehicles, and there is an ever-increasing demand for new and different accessories. Especially favored are devices for providing aesthetic illumination to the vehicle. Some popular illumination accessories include neon lighting for the underbelly of the vehicle, neon detailing around the license plate, and pinpoint illumination of the wheels.

Although it is known to employ various methods to personalize license plates, such as through the use of illumination or graphic design, an apparatus that allows figures or symbols on the exterior of the frame to become illuminated and/or otherwise visible on or from the sides of the license plate, without obscuring the face of the license plate, does not currently exist.

There is a need for an improved device for illuminating and personalizing decorative license plate that does not obscure the face of the plate. The present novel technology addresses this need.

### BRIEF DESCRIPTION OF THE DRAWINGS

FIG. 1 is a side perspective view of one possible embodiment license plate frame of the present novel technology.

FIG. 2 is a side perspective view of an alternative possible embodiment view of the embodiment of FIG. 1.

FIG. 3 is a side perspective view of an alternative possible embodiment view of the embodiment of FIG. 1.

FIG. 4 is an exploded side perspective view of the embodiment of FIG. 1

FIG. 5 is a front elevation view of a second embodiment license plate frame of the present novel technology.

FIG. 6 is a rear partial perspective view of the frame of FIG. 5.

FIG. 7 is an exploded perspective view of the frame of FIG. 5.

FIG. 8 is a front elevation schematic view of a third embodiment license plate frame system of the present novel technology.

FIG. 9A is a first front elevation view of the system of claim 8 showing a first projected image.

FIG. 9B is a second front elevation view of the system of claim 8 showing a second projected image.

### DESCRIPTION OF THE PREFERRED EMBODIMENTS

For the purposes of promoting an understanding of the principles of the novel technology and presenting its currently understood best mode of operation, reference will now be made to the embodiments illustrated in the drawings and specific language will be used to describe the same. It will nevertheless be understood that no limitation of the scope of the novel technology is thereby intended, with such alterations and further modifications in the illustrated device and such further applications of the principles of the novel technology as illustrated therein being contemplated as would normally occur to one skilled in the art to which the novel technology relates.

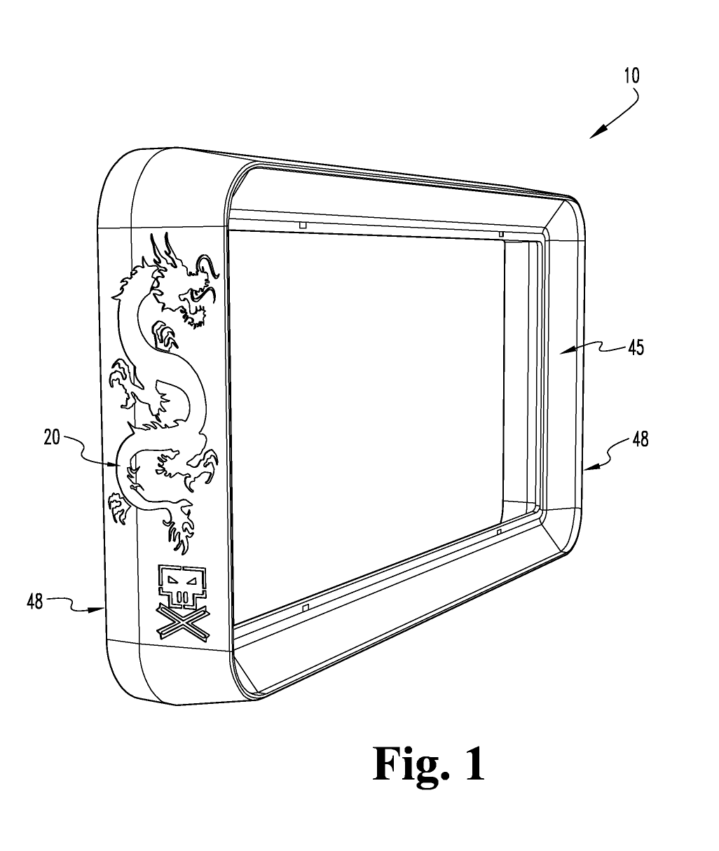

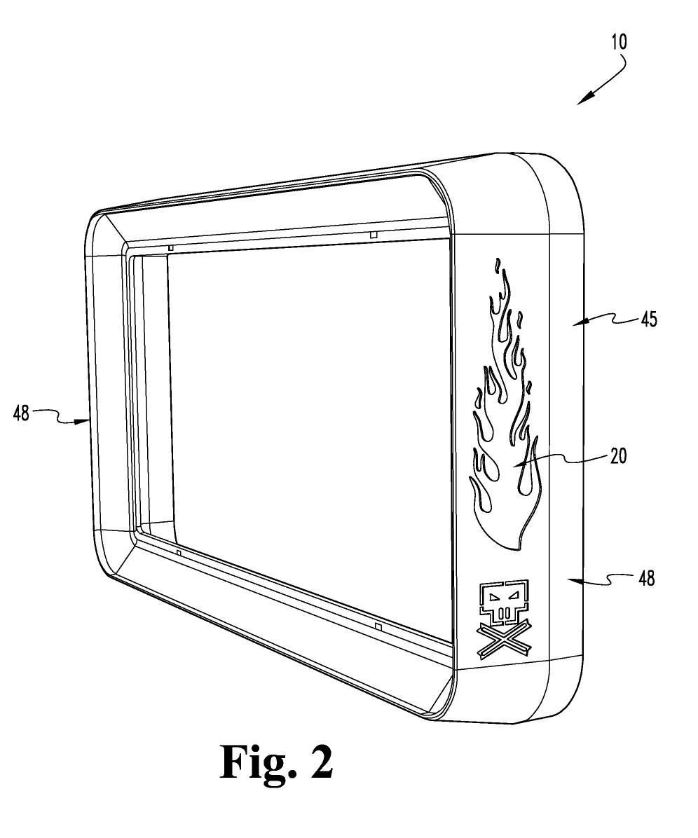

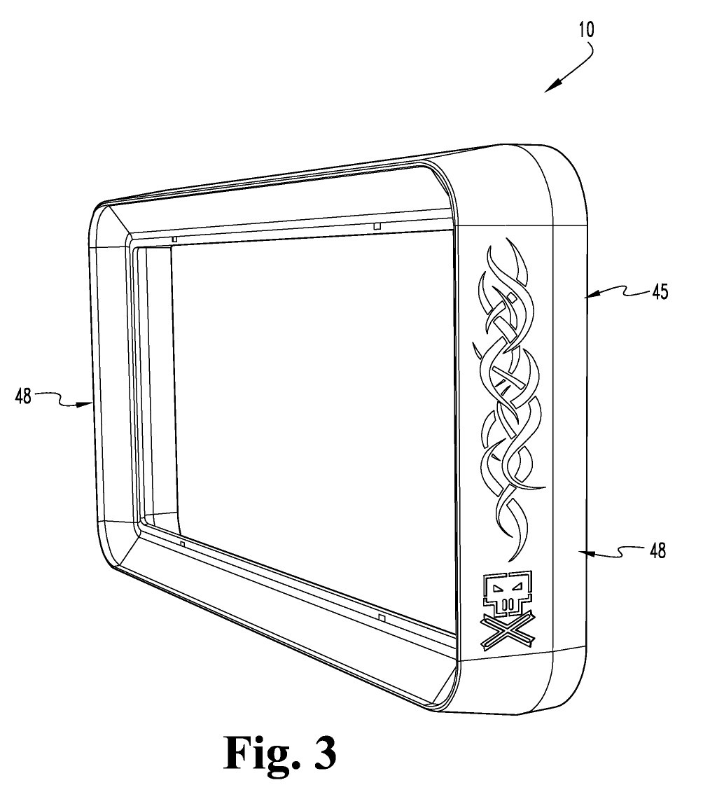

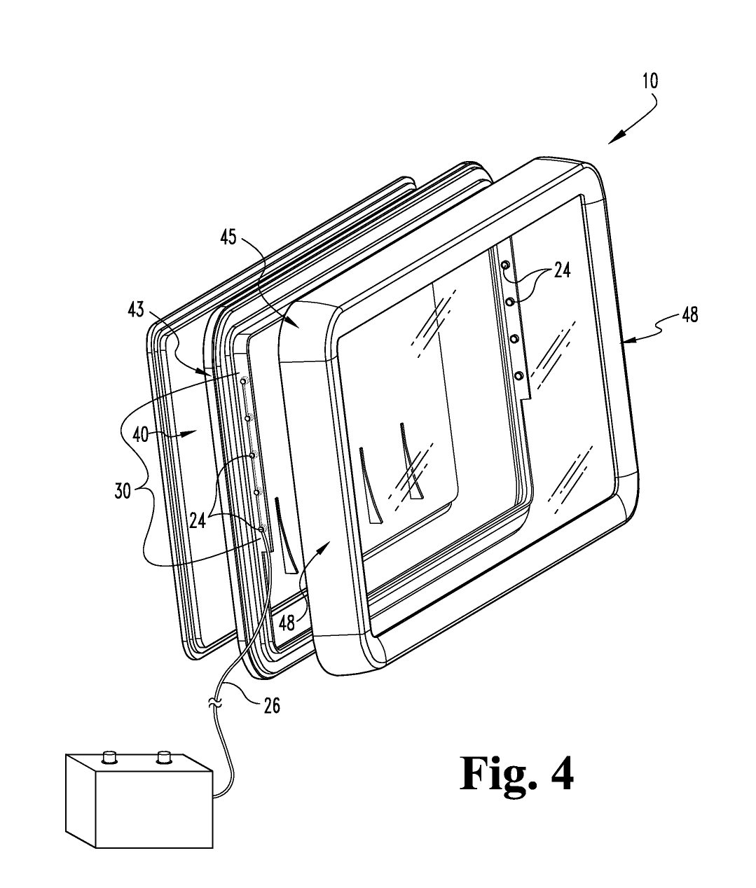

FIGS. 1-4 illustrate a first embodiment of the present novel technology, a decorative license plate frame system 10 for use with a vehicle such as an automobile, truck, motorcycle, or the like, to enable the illumination of embossed figures or symbols 20 (such as the dragon illustrated in FIG. 1, the flame illustrated in FIG. 2, or the design illustrated in FIG. 3, although any design, symbol, or shape may be utilized) through an internal lighting system typically located within a decorative frame 10. The frame system 10 generally includes a back plate 40, a flange 43, and a front cover portion 45 typically made of a suitable lightweight plastic or metal, and generally shaped to surround the perimeter of a standard license plate (although any shape or size may be utilized) without covering identifying numbers or letters of the plate indicia.

An embossed figure or symbol 20 may be cut from the vertical side member(s) 48 of the front cover portion 45, or any convenient location on the decorative license plate frame system 10. The cut-out item 20, produced through the use of a punch, a laser, a waterjet, or the like, allows light from a lighting assembly 30 that is typically mounted within the frame system 10 to illuminate embossed figures or symbols 20 on the exterior of the frame cover 45. The lighting assembly 30 preferably includes a plurality of light emitting diodes (LEDs) 24 electrically connected via wires 26 to an electrical power source 28 (such as the vehicle's battery.) The LEDs 24 are preferably of different colors, and more preferably, some or all of the LEDs 24 may be of the triluminary or multicolored variety, able to generate three (or more) colors on demand. Typically, the internal lighting system 30 may incorporate sequential lighting for effect and/or may generally be actuated directly or by a wireless remote, and may be controlled by an electronic controller to illuminate the individual LEDs 24 in a predetermined or random sequence or pattern.

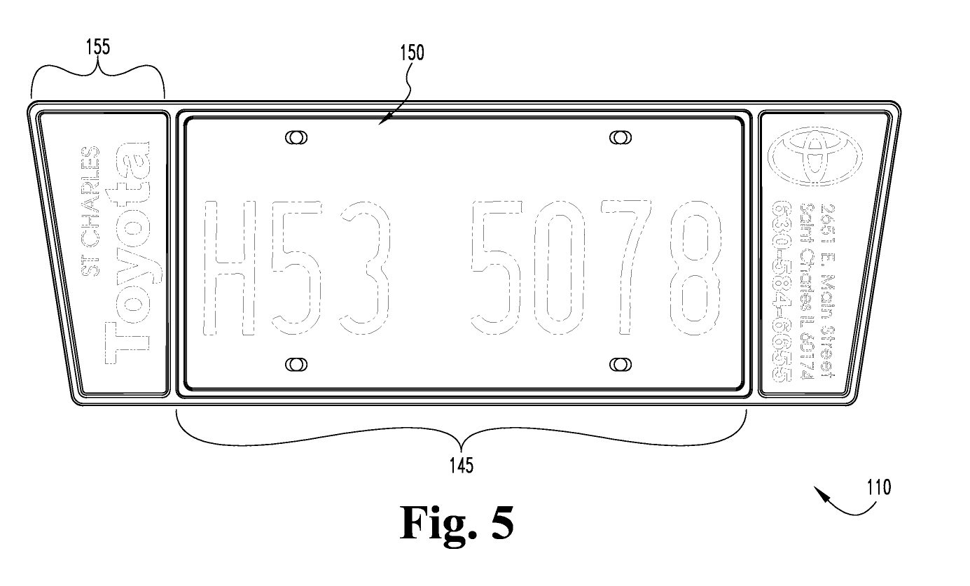

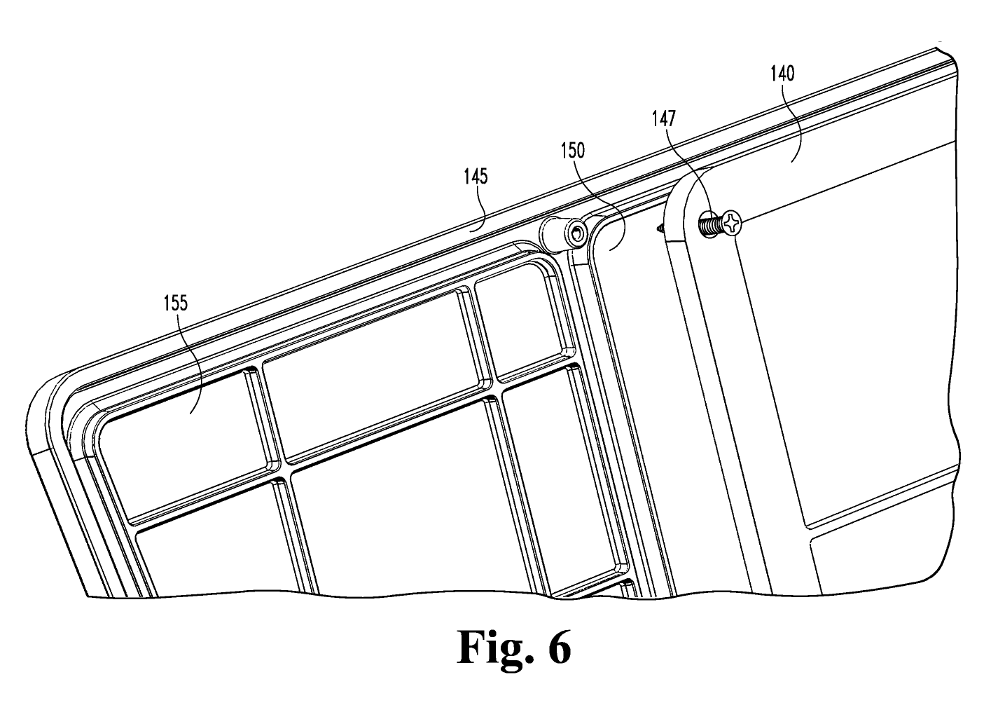

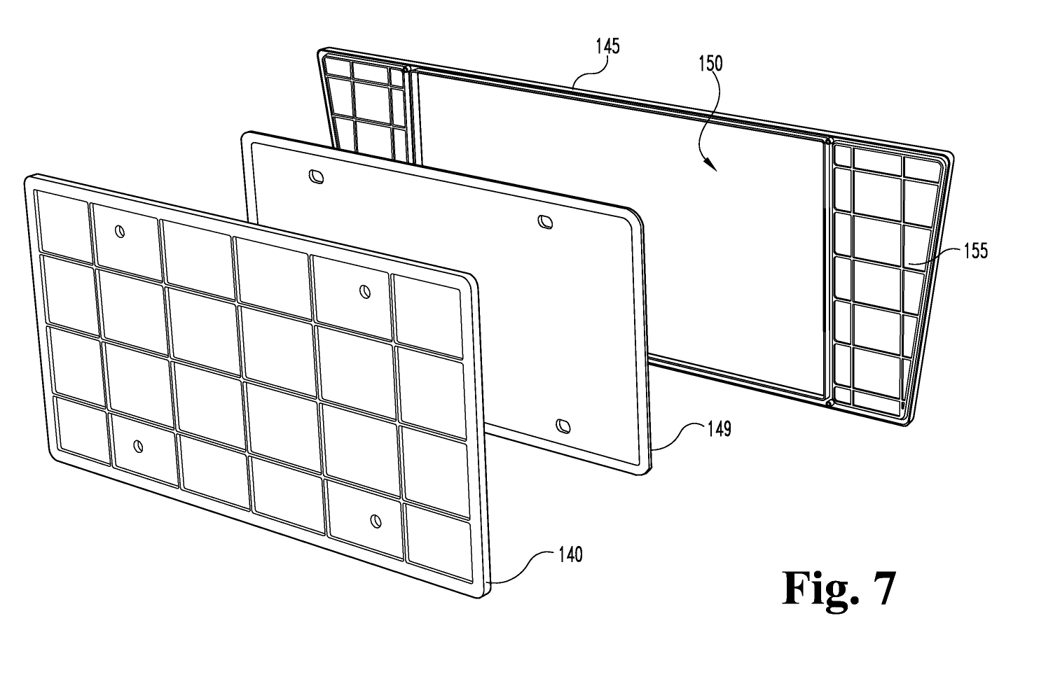

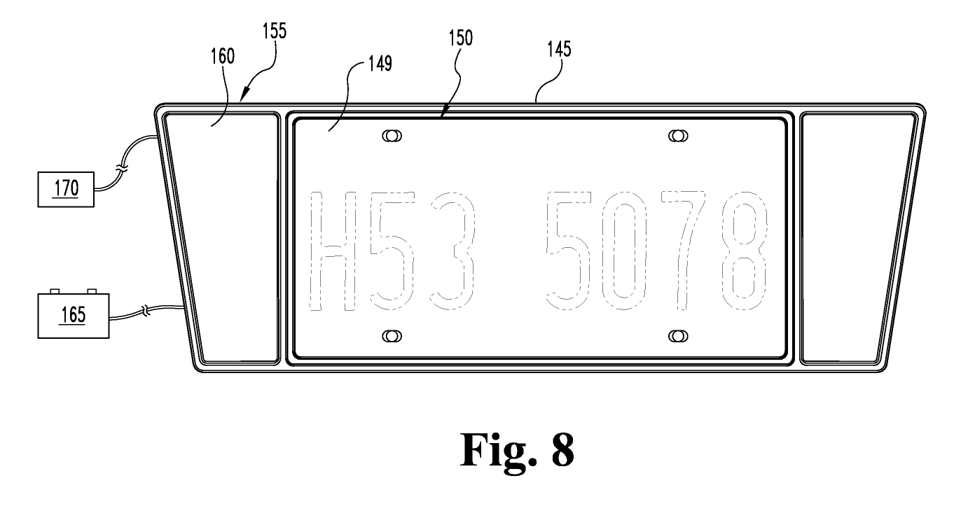

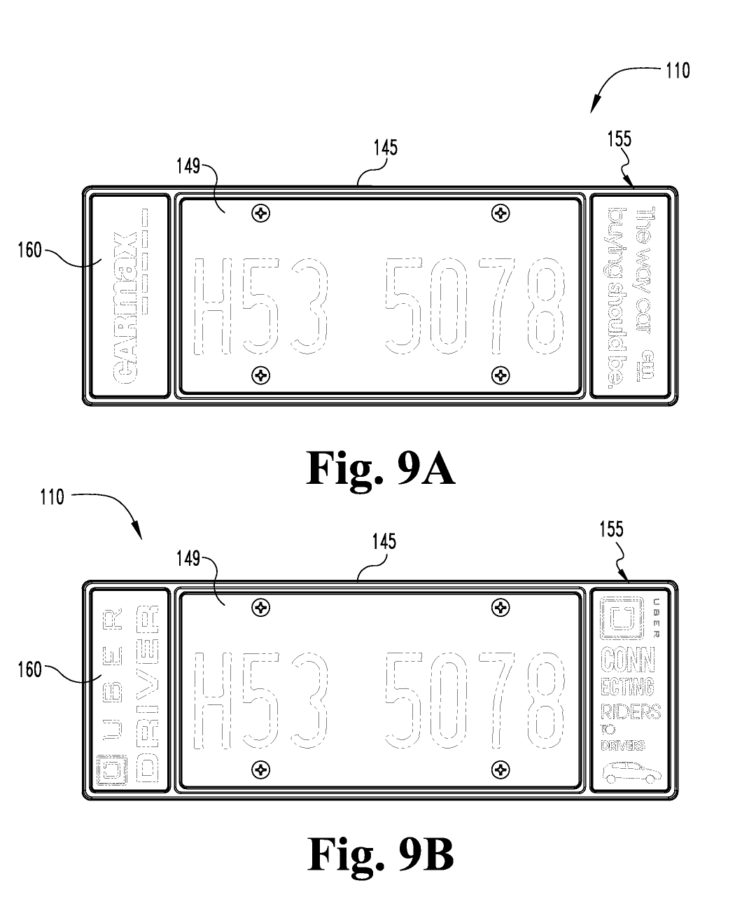

In another embodiment, as illustrated in FIGS. 5-7, a license plate frame assembly 110 having one or more advertising surfaces extending therefrom. The frame assembly 110 generally includes a back plate 140 and a front cover portion 145 which is typically made of a suitable lightweight plastic or metal, and generally shaped to surround the perimeter of a standard license plate 149 (although any shape or size may be utilized) and define a display window 150 without covering identifying numbers or letters of the plate indicia. The assembly further includes fasteners 147 to securely and removably connect the back plate 140 and the front cover portion 145. At least one side flange portion 155 extends from the front cover portion 145 away from the window 150. The side flange portion 155 is typically flat for receiving advertising information, such as a decal or other illustration. The side flange portion 155 may alternately include preprinted, embossed, illuminated or painted visual materials. In one embodiment, seen in FIGS. 8-9B, the side flange portion 155 includes a programmable LCD or like display screen 160, which is operationally connected with a power source 165 and a microprocessor 170, such as by a hardwired or remote or radio connection, to receive and display static or moving images.

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

What is claimed is:

1. A decorative license plate frame assembly comprising:
a partially transparent housing defining a windowed frame for mounting a license plate to a vehicle;
a light-emitting array positioned within the housing; and
a decorative panel connected to the side of the housing;
wherein energization of the light-emitting array illuminates the decorative panel.

2. The assembly of claim 1 wherein the panel extends away from the housing and is oriented parallel with the windowed frame.

3. The assembly of claim 1 wherein the panel is oriented perpendicular to the windowed frame.

4. The assembly of claim 3 wherein the panel includes a cutout portion.

5. The assembly of claim 2 wherein the panel includes an LCD display.

6. A license plate frame comprising:
a back plate member;
a frame member connectible to the back plate member for securing a license plate therebetween and defining a window through which a license plate secured therebetween is visible;
a first side panel connected to the frame member and extending away therefrom;
wherein the side panel is oriented parallel to the back plate member.

7. The license plate frame of claim 6 wherein the first side panel includes a visible message.

8. The license plate frame of claim 7 wherein the message is preprinted on the first side panel.

9. The license plate frame of claim 6 and further comprising a second side panel connected to the frame member and disposed opposite the first side panel.

10. The license plate frame of claim 6 wherein the side panel further comprises a liquid crystal display screen.

11. The license plate frame of claim 10 and further comprising:
a power source operationally connected to the liquid crystal display screen; and
an electronic controller operationally connected to the liquid crystal, display screen.

12. The license plate frame of claim 6 and further comprising:
a light source operationally connected to the frame member for illuminating the first side panel.

13. A method of advertising, comprising:
a) connecting a license plate frame to a vehicle, wherein the license plate frame defines a window through which a license plate may be observed and wherein at least one generally flat panel extends from the license plate frame and is oriented substantially parallel with the window; and
b) displaying advertising material on the at least one generally flat panel.

14. The method of claim 13 and further comprising:
c) mounting a license plate in the license plate frame, wherein the license plate is visible through the window.

15. The method of claim 13 wherein the at least one substantially flat panel is a liquid crystal display screen.

16. The method of claim 13 wherein the at least one substantially flat panel contains a preprinted message.

17. The method of claim 14 and further comprising:
d) illuminating the advertising material.
